(19) United States
(12) Patent Application Publication
(10) Pub. No.: US 2025/0077203 A1
(43) Pub. Date: Mar. 6, 2025

(54) INFORMATION PROCESSING APPARATUS, INFORMATION PROCESSING METHOD, AND NON-TRANSITORY COMPUTER READABLE MEDIUM

(71) Applicant: NEC Corporation, Tokyo (JP)

(72) Inventors: Shunichi KINOSHITA, Tokyo (JP); Yusuke Shimada, Tokyo (JP); Daiki Tanaka, Tokyo (JP); Daichi Arai, Tokyo (JP)

(73) Assignee: NEC Corporation, Tokyo (JP)

(21) Appl. No.: 18/754,341

(22) Filed: Jun. 26, 2024

(30) Foreign Application Priority Data
Sep. 4, 2023 (JP) 2023-142860

(51) Int. Cl. G06F 8/41

(52) U.S. Cl. CPC G06F 8/433

(57) ABSTRACT

An information processing apparatus includes: a dependency analysis unit configured to execute a flow analysis on an inspection target program and analyze dependency relationships between variables in a process flow included in the inspection target program, the dependency relationships including a data dependency relationship and a control dependency relationship; and a directed graph generation unit configured to generate, based on results of analyzing the dependency relationships, a directed graph having a part of the inspection target program which generates the control dependency relationship as a node regarding the process flow.

### INCORPORATION BY REFERENCE

This application is based upon and claims the benefit of priority from Japanese patent application No. 2023-142860, filed on Sep. 4, 2023, the disclosure of which is incorporated herein in its entirety by reference.

### TECHNICAL FIELD

The present disclosure relates to an information processing apparatus, an information processing method, and a program.

### BACKGROUND ART

As related art, Japanese Patent No. 5941859 discloses a verification apparatus that performs a data flow analysis on a source code of a program. The data flow analysis means an analysis for tracing, by focusing on data in a program such as variables and objects, a flow of processing related to this data. The verification apparatus disclosed in Japanese Patent No. 5941859 extracts, from the source code, an input point node to which data is input and an output point node from which data is output in the data flow analysis. The verification apparatus generates a directed graph indicating a data flow including nodes from the input point node to the output point node.

In Japanese Patent No. 5941859, the verification apparatus extracts, besides the input point node and the output point node, a sanitization node from the source code. The sanitization node corresponds to processing for sanitizing special letters which cause vulnerability in data. The verification apparatus extracts, from among the nodes included in the generated directed graph, nodes on a path that do not pass through the sanitization node as compromised nodes. Further, the verification apparatus extracts, from among the nodes included in the generated directed graph, nodes located downstream of the sanitization node as downstream nodes. Further, the verification apparatus extracts, from among the nodes included in the generated directed graph, nodes located upstream of the sanitization node as upstream nodes.

The verification apparatus extracts, based on the compromised nodes, the downstream nodes, and the upstream nodes that have been extracted, candidate nodes indicating candidates of nodes where sanitization processing is arranged. The verification apparatus extracts, for example, nodes included in a candidate set obtained by excluding a set of downstream nodes and a set of upstream nodes from a set of compromised nodes as candidate nodes. The verification apparatus causes an output unit to output information indicating positions on the source code that correspond to the extracted candidate nodes.

When an organization uses software inside this organization or provides software for another organization, the organization is often required to guarantee the quality of this software. In this case, it may be required for the organization to make sure that this software is free of an undocumented function, which allows access to a computer system or internal data, in addition to making sure that this software is bug free. This undocumented function is also called a backdoor.

In general, functions such as a backdoor are often triggered when data meets specific conditions. The verification apparatus disclosed in Japanese Patent No. 5941859 is able to perform a data flow analysis to verify whether or not the sanitization node is arranged between the input point node and the output point node. However, the verification apparatus disclosed in Japanese Patent No. 5941859 is not suitable for verifying the presence or the absence of a specific function executed when specific conditions are met.

### SUMMARY

One of the objects of the present disclosure is to provide an information processing apparatus, an information processing method, and a program which enable a user to easily inspect the presence or the absence of the function executed when specific conditions are met.

An information processing apparatus according to a first aspect of the present disclosure includes: a dependency analysis unit configured to execute a flow analysis on an inspection target program and analyze dependency relationships between variables in a process flow included in the inspection target program, the dependency relationships including a data dependency relationship and a control dependency relationship; and a directed graph generation unit configured to generate, based on results of analyzing the dependency relationships, a directed graph having a part of the inspection target program that generates the control dependency relationship as a node regarding the process flow.

An information processing method according to a second aspect of the present disclosure includes: executing a flow analysis on an inspection target program and analyzing dependency relationships between variables in a process flow included in the inspection target program, the dependency relationships including a data dependency relationship and a control dependency relationship; and generating, based on results of analyzing the dependency relation ships, a directed graph having a part of the inspection target program that generates the control dependency relationship as a node regarding the process flow.

A program according to a third aspect of the present disclosure causes a computer to execute processing including: executing a flow analysis on an inspection target program and analyzing dependency relationships between variables in a process flow included in the inspection target program, the dependency relationships including a data dependency relationship and a control dependency relationship; and generating, based on results of analyzing the dependency relationships, a directed graph having a part of the inspection target program that generates the control dependency relationship as a node regarding the process flow.

### BRIEF DESCRIPTION OF DRAWINGS

The above and other aspects, features, and advantages of the present disclosure will become more apparent from the following description of certain example embodiments when taken in conjunction with the accompanying drawings, in which:

FIG. 1 is a block diagram showing one example of a schematic configuration of an information processing apparatus according to the present disclosure;

FIG. 2 is a block diagram showing one example of a configuration of a first information processing apparatus according to the present disclosure;

FIG. 3 is a diagram showing one example of a process flow included in an inspection target program;

FIG. 4 is a diagram showing one example of a source code of the inspection target program;

FIG. 5 is a diagram showing one example of a list of source functions and a list of sink functions;

FIG. 6 is a diagram showing one example of a table showing results of analyzing dependency relationships;

FIG. 7 is a diagram showing one example of a directed graph generated from the results of analyzing the dependency relationships;

FIG. 8 is a diagram showing another example of a generated directed graph;

FIG. 9 is a flowchart showing an operation procedure in the information processing apparatus;

FIG. 10 is a block diagram showing one example of a configuration of a second information processing apparatus according to the present disclosure;

FIG. 11 is a diagram showing one example of a directed graph in which nodes are converted into units of functions;

FIG. 12 is a block diagram showing one example of a configuration of a third information processing apparatus according to the present disclosure;

FIG. 13 is a diagram showing one example of a graph indicating a function call relationship;

FIG. 14 is a diagram showing one example of a directed graph generated by a graph integration unit;

FIG. 15 is a diagram showing another example of the directed graph generated by the graph integration unit;

FIG. 16 is a diagram showing yet another example of the directed graph generated by the graph integration unit;

FIG. 17 is a diagram showing a modified example of the directed graph; and

FIG. 18 is a block diagram showing one example of a hardware configuration of a computer apparatus.

### EXAMPLE EMBODIMENT

Prior to giving the description of example embodiments of the present invention, an outline of the present disclosure will be described. FIG. 1 shows one example of a schematic configuration of an information processing apparatus according to the present disclosure. An information processing apparatus 10 includes a dependency analysis unit 11 and a directed graph generation unit 12.

The dependency analysis unit 11 executes a flow analysis on an inspection target program. The dependency analysis unit 11 analyzes, in the flow analysis, dependency relationships between variables in a process flow included in the inspection target program. The dependency relationships that are analyzed include a data dependency relationship and a control dependency relationship. The directed graph generation unit 12 generates, based on results of analyzing the dependency relationships, a directed graph having parts of the inspection target program which generate the control dependency relationship as nodes regarding the process flow.

In the present disclosure, the directed graph generation unit 12 generates a directed graph having parts related to the control dependency relationship, of the dependency relationships analyzed by the dependency analysis unit 11, as nodes. The directed graph indicates dependency relationships of nodes related to the control dependency relationship. A user is able to know under what conditions processing in the process flow will be performed in the process flow by referring to the directed graph. Accordingly, the user is able to easily inspect whether or not a function executed when specific conditions are met exists in the inspection target program. In this manner, the information processing apparatus 10 enables the user to easily inspect the presence or the absence of the function executed when specific conditions are met.

Hereinafter, with reference to the drawings, example embodiments of the present disclosure will be described in detail. For the sake of clarification of the explanation, the following descriptions and drawings are omitted and simplified as appropriate. In each drawing, the same and similar elements have the same reference signs, and repeated descriptions have been omitted as appropriate.

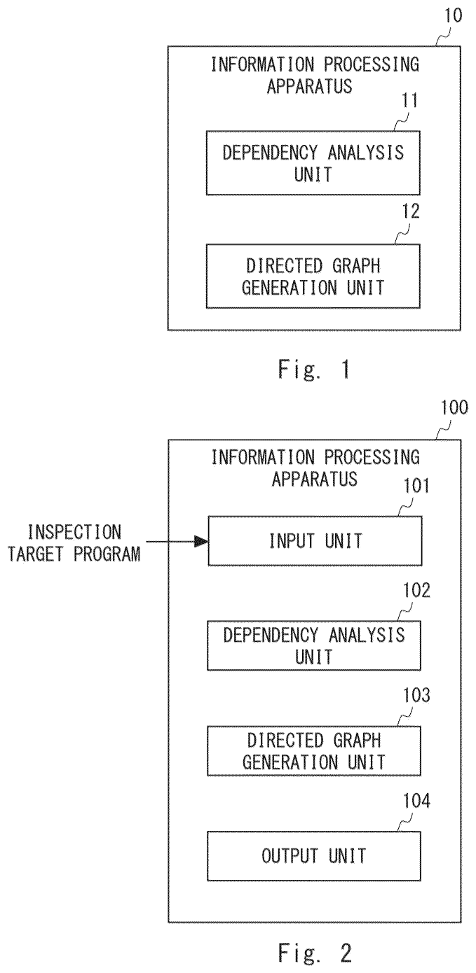

A first example embodiment of the present disclosure will be described. FIG. 2 shows one example of a configuration of a first information processing apparatus according to the present disclosure. An information processing apparatus 100 includes an input unit 101, a dependency analysis unit 102, a directed graph generation unit 103, and an output unit 104. The information processing apparatus 100 may be physically configured as an apparatus that includes one or more processors and one or more memories. In the information processing apparatus 100, one or more processors executes processing in accordance with instructions read out from one or more memories, whereby at least some of the functions of the respective units of the information processing apparatus 100 may be implemented. The information processing apparatus 100 may also be referred to as a program inspection apparatus. The information processing apparatus 100 corresponds to the information processing apparatus 10 shown in FIG. 1.

The input unit 101 acquires an inspection target program. The input unit 101 acquires, for example, a source code of the inspection target program. Further, the input unit 101 acquires a list of functions serving as a starting point of the analysis and a list of functions serving as an end point of the analysis. The function serving as the starting point of the analysis is also called a source function. The function serving as the end point of the analysis is also called a sink function. In this example embodiment, it is assumed that the source function is a function for externally receiving data, such as a function for receiving data from a network. It is further assumed that the sink function is a function where predetermined processing that may have a significant security impact on a system on which a program operates is executed, such as a function for executing a shell command.

Here, an undocumented function which may cause operations unintended by a user is often implemented to be activated when externally input data meets specific conditions. The undocumented function includes a backdoor introduced into a program by a malicious person. Further, the undocumented function may include a function that is incorporated in the program for debugging, the function being the one which should have been removed after the program is developed. When it is checked whether or not there is an undocumented function in the inspection target program, external input needs to be especially focused on, and a part where data dependent on external input is used for conditional branch is important. In this example embodiment, the information processing apparatus 100 may be used to support the user in inspecting whether or not the data externally input is being used to trigger execution of a dangerous function.

The dependency analysis unit 102 executes the flow analysis on the inspection target program. The dependency analysis unit 102 analyzes, in the flow analysis, a process flow starting from any one of the functions (first function) included in the list of source functions and ending with any one of the functions (second function) included in the list of sink functions. Further, the dependency analysis unit 102 analyzes dependency relationships between variables associated with the process flow. The dependency relationships between variables include a data dependency relationship and a control dependency relationship. The data dependency relationship indicates a relationship in which a value of a variable of a dependency destination is derived from a variable of a dependency source by assignment, copying, or processing. The data dependency relationship generally does not involve branching of processing. On the other hand, the control dependency relationship indicates a relationship in which the value of the variable of the dependency destination is changed or generated as a result of branching of processing depending on the variable of the dependency source. The results of analyzing the dependency relationships include the type of dependency, the variable of the dependency source, and the variable of the dependency destination.

For example, the dependency analysis unit 102 analyzes, in the flow analysis, variables, or data, having a data dependency relationship or a control dependency relationship directly or indirectly with variables, or data, handled in the source function. In the analysis of the dependency relationships, functions may be handled like variables. The dependency analysis unit 102 extracts parts of the inspection target program that generate the data dependency relationship and the control dependency relationship. For example, the dependency analysis unit 102 extracts codes of lines that generate the data dependency relationship and the control dependency relationship from the source code of the inspection target program. The dependency analysis unit 102 corresponds to the dependency analysis unit 11 shown in FIG. 1.

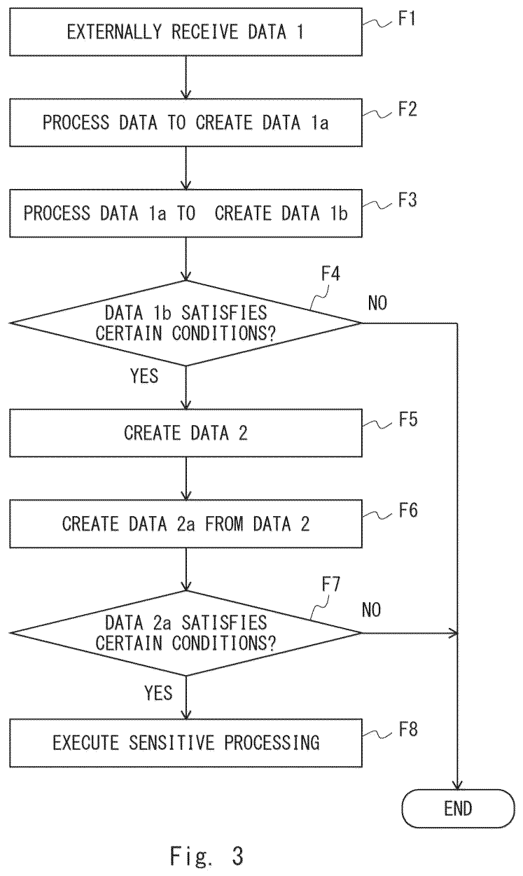

FIG. 3 shows one example of a process flow included in the inspection target program. The process flow shown in FIG. 3 will be described. In this process flow, the program externally receives data 1 (F1). F1 corresponds to the source function. After that, the program processes data 1 to create data 1a (F2). Further, the program processes the data 1a to create data 1b (F3). The program determines whether or not the data 1b meets predetermined conditions (F4). When it is determined that the data 1b does not meet the predetermined conditions, the program ends the processing of this process flow.

When it is determined that the data 1b meets the predetermined conditions in F4, the program creates data 2 (F5). After that, the program creates the data 2a from the data 2 (F6). The program determines whether or not the data 2a meets predetermined conditions (F7). When it is determined that the data 2a does not meet the predetermined conditions, the program ends the processing of this process flow. When it is determined that the data 2a meets the predetermined conditions, the program executes sensitive processing (F8). F8 corresponds to the sink function.

In the process flow shown in FIG. 3, the dependency analysis unit 102 analyzes data which has a data dependency relationship and a control dependency relationship with the data 1 handled in F1 in which the source function is performed. The data 1a created in F2 is data created by processing the data 1 received in F1. Therefore, the dependency analysis unit 102 analyzes that the data 1a and the data 1 have a data dependency relationship. Further, the data 1b created in F3 is data generated by processing the data 1a created in F2. Therefore, the dependency analysis unit 102 analyzes that the data 1b and the data 1a have a data dependency relationship.

Further, when it is determined that the data 1b meets the predetermined conditions in F4, the data 2 is created in F5. The data 2 is created as a result of branching of processing using the data 1b as a branch condition. Therefore, the dependency analysis unit 102 analyzes that the data 2 and the data 1b have a control dependency relationship. Further, the data 2a created in F6 is data created by processing the data 2 created in F5. Therefore, the dependency analysis unit 102 analyzes that the data 2a and the data 2 have a data dependency relationship.

When it is determined in F7 that the data 2a meets the predetermined conditions, sensitive processing is executed in F8. In other words, the sensitive processing is executed as a result of branching of processing using the data 2a as a branch condition. In this case, the dependency analysis unit 102 analyzes that sensitive processing and the data 2a have a control dependency relationship. By tracking the data dependency relationship and the control dependency relationship, it can be found that the data 2a which is used as a branch condition to the sensitive processing has a dependency relationship with the data 1 received in F1. In this case, it is possible that the data 1 is used to trigger an unintended function such as a backdoor where sensitive processing is executed.

Note that the data dependency relationship is not necessarily limited to a dependency relationship that does not involve a conditional branch. For example, when the conditional branch is used in a process of data processing, the dependency analysis unit 102 may determine that there is a data dependency relationship between data before processing and data after processing. For example, data processing is considered which includes processing for determining whether or not data, which is a character string, includes a lowercase alphabet letter, and, converting, when this data includes a lowercase letter, a lowercase letter to an uppercase letter. In this case, the conditional branch, that is, whether or not the letters are lowercase alphabet letters is used in the process of data processing. In this case, the dependency analysis unit 102 may determine that there is a data dependency relationship between data before processing and data in which lowercase letters are converted into uppercase letters.

When the data having a dependency relationship with the data handled in the source function is used for the branch condition in the branching to the sink function, the dependency analysis unit 102 stores the analyzed data dependency relationship and the analyzed control dependency relationship in a storage device that is not shown as results of the analysis. The dependency analysis unit 102 stores parts that generate the data dependency relationship or the control dependency relationship extracted from the inspection target program in the storage device as well. When data dependent on the data handled in the source function is not used as a branch condition to the sink function in the process flow, the dependency analysis unit 102 does not need to store the dependency relationship and the control dependency relationship analyzed for the process flow in the storage device.

The directed graph generation unit 103 generates a directed graph in which parts of the inspection target program which generate the control dependency relationship, of the dependency relationships analyzed by the dependency analysis unit 102, are set to be nodes and the nodes are connected to each other based on the dependency relationships. The directed graph generation unit 103 generates, for example, a directed graph in which lines that generate the control dependency relationship extracted from the source code of the inspection target program are set to be nodes and the nodes are connected to each other in accordance with the dependency relationships. The directed graph generation unit 103 may add a node indicating the source function and a node indicating the sink function to the directed graph. The output unit 104 causes a screen of a display device that is not shown to display the directed graph generated by the directed graph generation unit 103. The directed graph generation unit 103 corresponds to the directed graph generation unit 12 shown in FIG. 1.

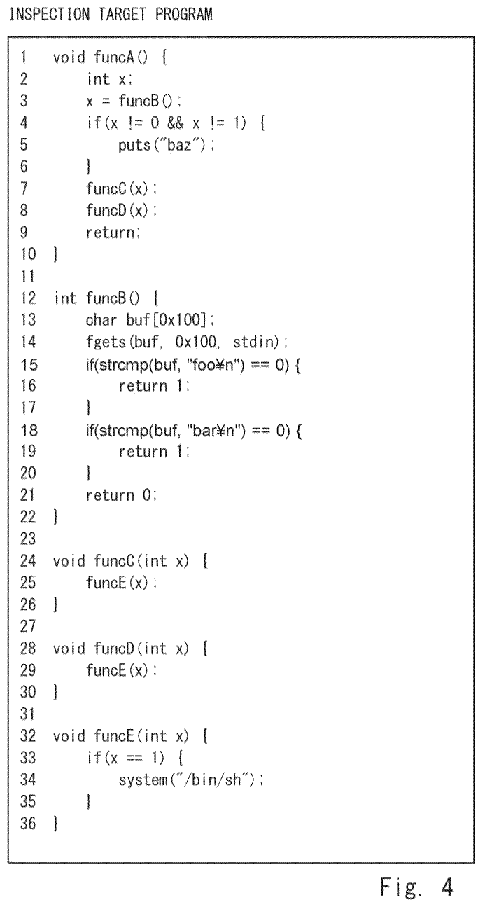

Hereinafter, the explanation will be given with specific examples. FIG. 4 shows one example of the source code of the inspection target program. The source code is described according to, for example, a predetermined language. FIG. 5 shows one example of a list of source functions and a list of sink functions. It is assumed that the list of the source functions and the list of the sink functions are input into the input unit 101 in advance by, for example, an administrator. The user enters the source code of the inspection target program into the input unit 101. The dependency analysis unit 102 analyzes the source code to analyze the data dependency relationship and the control dependency relationship between variables associated with a process flow having the source function as the starting point and the sink function as the end point.

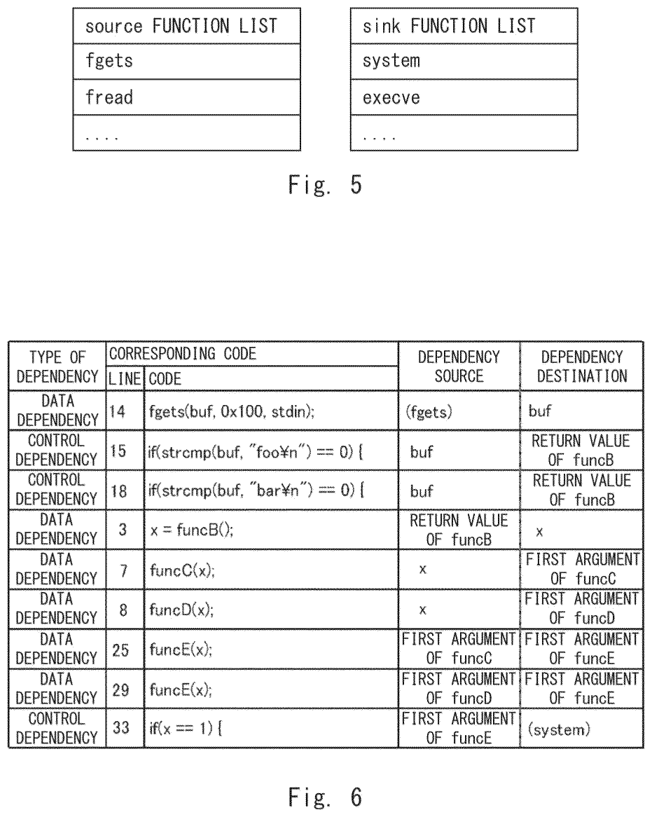

FIG. 6 shows one example of a table indicating the results of analyzing the dependency relationships. The dependency analysis unit 102 finds, for example, fgets included in the source function list shown in FIG. 5 on the line 14 of the source code shown in FIG. 4. On the line 14 of the source code, a character string input from standard input is stored in a variable buf using the fgets function. The dependency analysis unit 102 records dependency relationships in which the type of dependency is data dependency, the dependency source is fgets, and the dependency destination is buf in a table showing the results of analyzing the dependency relationships. The dependency analysis unit 102 further records line numbers of the source code that generate a data dependency relationship, and the codes of these lines in the table.

The dependency analysis unit 102 finds that the variable buf is used for a conditional branch on the line 15 of the source code. The dependency analysis unit 102 records dependency relationships in which the type of dependency is a control dependency, the dependency source is buf, and the dependency destination is a return value of funcB in the table. The dependency analysis unit 102 further records line numbers of the source code that generate a control dependency relationship, and the codes of these lines in the table. Likewise, the dependency analysis unit 102 records, regarding the line 18 of the source code, information on the control dependency relationship in the table. The dependency analysis unit 102 records, regarding the line 3 of the source code where a return value of funcB is assigned to x, information in which the type of dependency is data dependency in the table. The dependency analysis unit records, regarding the part where the function is called using a variable x as an argument, information in which the type of dependency is data dependency in the table.

The dependency analysis unit 102 finds that the variable x, which is a first argument of funcE, is used as a branch condition to system included in the list of sink functions shown in FIG. 5 on the line 33 of the source code. The dependency analysis unit 102 records dependency relationships in which the type of dependency is control dependency, the dependency source is the first argument of funcE, and the dependency destination is system in a table showing the results of analyzing the dependency relationships. Further, the dependency analysis unit 102 records the line numbers of the source code that generate the control dependency relationship, and the codes of these lines in the table. According to the aforementioned operation, the table shown in FIG. 6 is created.

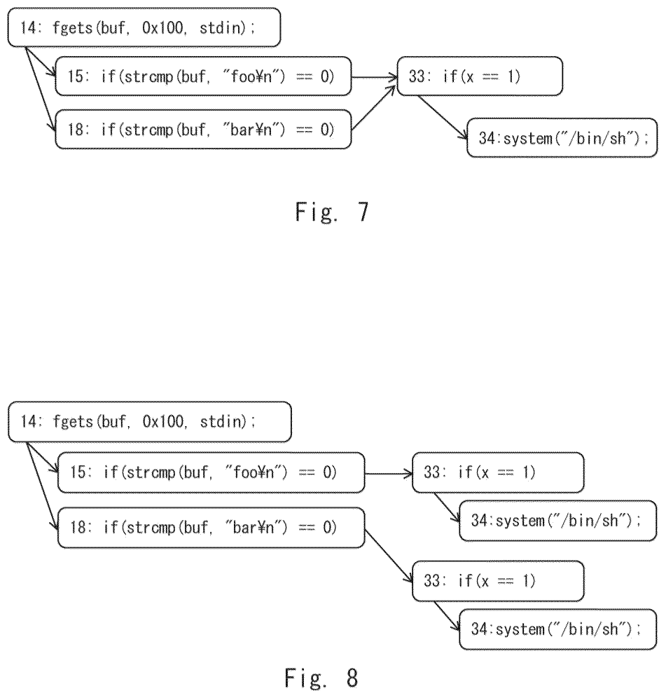

FIG. 7 shows one example of the directed graph generated from the results of analyzing the dependency relationships shown in FIG. 6. The directed graph generation unit 103 acquires codes in which the type of dependency is control dependency from the table shown in FIG. 6. In the example shown in FIG. 6, the directed graph generation unit 103 acquires codes on the lines 15, 18, and 33 of the source code as codes that generate the control dependency. The directed graph generation unit 103 generates a directed graph in which codes on the lines 15, 18, and 33 of the source code are set to be nodes and these nodes are connected to one another based on dependency relationship between the nodes.

Further, the directed graph generation unit 103 acquires the code on the line 14 of the source code that corresponds to the source function. The directed graph generation unit 103 acquires a code on the line 34 of the source code that corresponds to the sink function. As shown in FIG. 7, the directed graph generation unit 103 may add the code on the line 14 of the source code to the directed graph as a node which serves as the starting point and add the code on the line 34 of the source code to the directed graph as a node which serves as the end point.

FIG. 8 shows another example of the generated directed graph. In the example shown in FIG. 7, the node indicating the code on the line 15 of the source code and the node indicating the code on the line 18 of the source code are connected to one node. As shown in FIG. 8, the directed graph generation unit 103 may expand the directed graph indicating dependency relationships in a tree form. In this case, a path from the node indicating the code on the line 15 of the source code to node indicating the code on the line 34 of the source code via the node indicating the code on the line 33 of the source code and a path from the node indicating the code on the line 18 of the source code to the node indicating the code on the line 34 of the source code via the node indicating the code on the line 33 of the source code are likely to be recognized as paths different from each other.

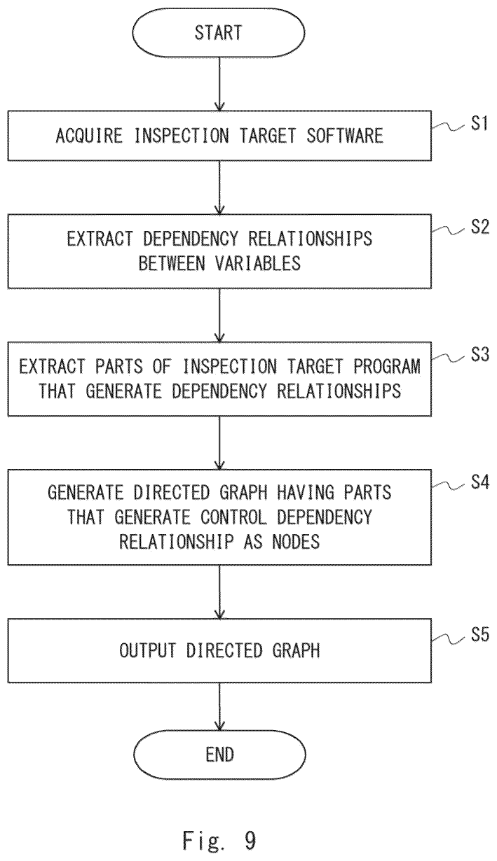

Next, an operation procedure will be described. FIG. 9 shows an operation procedure in the information processing apparatus 100. The operation procedure of the information processing apparatus 100 corresponds to an information processing method or a program inspection method. The input unit 101 acquires the inspection target program (Step S1). In Step S1, the input unit 101 acquires, for example, a source code of the inspection target program. The dependency analysis unit 102 executes a flow analysis on the inspection target program and extracts dependency relationships between variables associated with the process flow (Step S2). The extracted dependency relationships include a data dependency relationship and a control dependency relationship. Further, the dependency analysis unit 102 extracts parts of the inspection target program that generate the dependency relationships (Step S3).

The directed graph generation unit 103 generates a directed graph having parts that generate the control dependency relationship as nodes based on the extracted dependency relationships (Step S4). The output unit 104 outputs the generated directed graph to the user (Step S5). The output unit 104 displays the directed graph on, for example, the screen of the display device. The user can check whether or not the data that the source function has externally received is used as a trigger of an unintended function such as a backdoor by checking the displayed nodes indicating the parts that generate the control dependency relationship.

In this example embodiment, the dependency analysis unit 102 analyzes dependency relationships between variables in the process flow. In particular, when a function for externally receiving data is registered in a list of source functions, the dependency analysis unit 102 analyzes variables or data having a dependency relationship with the data that the source function has externally received. The directed graph generation unit 103 generates a directed graph having parts that generate the control dependency relationship, of the parts that generate dependency relationships, as nodes in the process flow. According to this procedure, only the processing related to the control dependency and dependency relationships thereof may be selectively displayed in the directed graph. In this case, it is possible to selectively display a part where processing is branched depending on the input data in the directed graph. Therefore, the user can check whether or not there is a backdoor that is activated when the external input meets the specific conditions relatively easily.

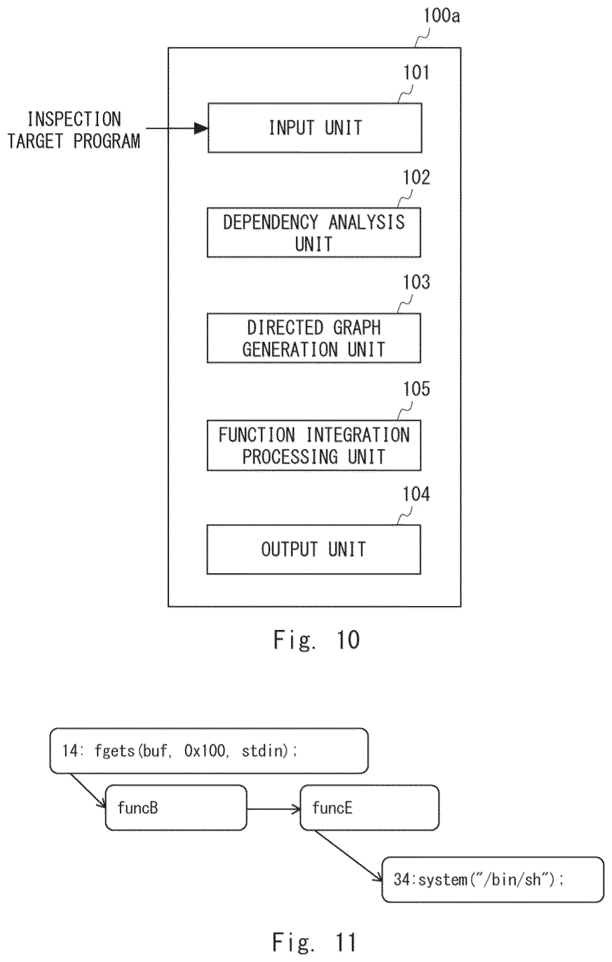

Next, a second example embodiment of the present disclosure will be described. FIG. 10 shows one example of a configuration of a second information processing apparatus according to the present disclosure. A second information processing apparatus 100a includes, besides the components of the information processing apparatus 100 shown in FIG. 2, a function integration processing unit 105.

In this example embodiment, besides the operations described in the first example embodiment, the dependency analysis unit 102 extracts information of the functions which codes of parts generating a control dependency relationship belong to as attribute function information. Further, the directed graph generation unit 103 generates a directed graph having functions which parts that generate the control dependency relationship belong to as nodes using the attribute function information extracted by the dependency analysis unit 102. In other words, the directed graph generation unit 103 converts the nodes in the directed graph from the units of codes to the units of functions. The function integration processing unit 105 integrates, when two or more nodes belong to one function, two or more nodes that belong to one function into one node.

FIG. 11 shows one example of the directed graph in which nodes are converted into the units of functions. For example, the dependency analysis unit 102 extracts information indicating that the line 15 of the source code shown in FIG. 4 belongs to funcB. Further, the dependency analysis unit 102 extracts information indicating that the line 18 of the source code shown in FIG. 4 that generates a control dependency relationship belongs to funcB. The dependency analysis unit 102 extracts information indicating that the line 33 of the source code shown in FIG. 4 that generates a control dependency relationship belongs to funcE.

The directed graph generation unit 103 generates a directed graph having functions which codes for generating a control dependency relationship belongs to as nodes. At this time, since each of the codes on the lines 15 and 18 of the source code belongs to funcB, the function integration processing unit 105 integrates these codes into one node indicating funcB. The output unit 104 causes the screen of the display device to display the directed graph in which nodes are converted into the units of functions.

In the directed graph shown in FIG. 7 illustrated in the first example embodiment, a code that generates a control dependency relationship is displayed in each node. On the other hand, in the directed graph shown in FIG. 11, a function which the code for generating the control dependency relationship belongs to is displayed in each node. Therefore, according to this example embodiment, it is possible to selectively display the functions related to the control dependency and the relationship therebetween. The other effects are similar to those described in the first example embodiment.

A third example embodiment of the present disclosure will be described. FIG. 12 shows one example of a configuration of a third information processing apparatus according to the present disclosure. A third information processing apparatus 100b includes, besides the components of the second information processing apparatus 100a shown in FIG. 10, a function call relationship extraction unit 106 and a graph integration unit 107.

The function call relationship extraction unit 106 extracts a call relationship of functions in an inspection target program. The function call relationship extraction unit 106 analyzes, for example, a source code of the inspection target program acquired by the input unit 101 and extracts a call relationship of functions including a source function and a sink function. The function call relationship extraction unit 106 outputs a graph indicating the extracted call relationship of functions to the graph integration unit 107.

The graph integration unit 107 acquires a directed graph in which nodes are converted into units of functions from the function integration processing unit 105. This directed graph indicates a control dependency relationship. Further, the graph integration unit 107 acquires a graph indicating a call relationship of functions from the function call relationship extraction unit 106. The graph integration unit 107 integrates the directed graph indicating the control dependency relationship with the graph indicating the function call relationship to generate a directed graph that shows the control dependency relationship and the function call relationship.

In this example embodiment, the dependency analysis unit 102 may extract attribute function information for codes that generate a data dependency relationship as well. The graph integration unit 107 may omit, from the integrated graph, nodes of functions that are not related to either the data dependency relationship or the control dependency relationship, of the functions included in the inspection target program. The output unit 104 may cause the screen of the display device to display the directed graph generated by the graph integration unit 107.

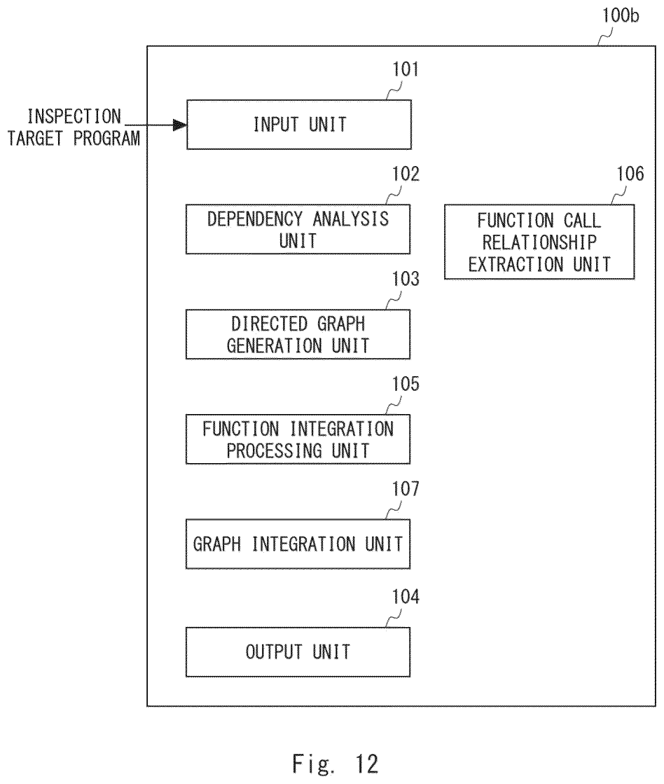

FIG. 13 shows one example of a graph showing the function call relationship. The function call relationship extraction unit 106 analyzes, for example, the source code shown in FIG. 4, and analyzes from which function each function is called. The graph shown in FIG. 13 indicates that each of funcB, funcC, and funcD is called from funcA. Further, the graph shown in FIG. 13 indicates that funcE is called from funcC and funcD. Further, the graph shown in FIG. 13 indicates that fgets, which is a source function, is called from funcB. Further, the graph shown in FIG. 13 indicates that system, which is a sink function, is called from funcE.

FIG. 14 shows one example of a directed graph generated by the graph integration unit 107. The graph integration unit 107 generates the directed graph shown in FIG. 14 by integrating, for example, the directed graph shown in FIG. 11 with the graph showing the call relationship of the functions shown in FIG. 13. The graph integration unit 107 generates the directed graph shown in FIG. 14 by adding arrows showing the dependency relationships indicated in the directed graph shown in FIG. 11 to the graph showing the call relationship of the functions shown in FIG. 13. In this case, the user can easily know the call relationship of the functions in the inspection target program, and the control dependency relationship.

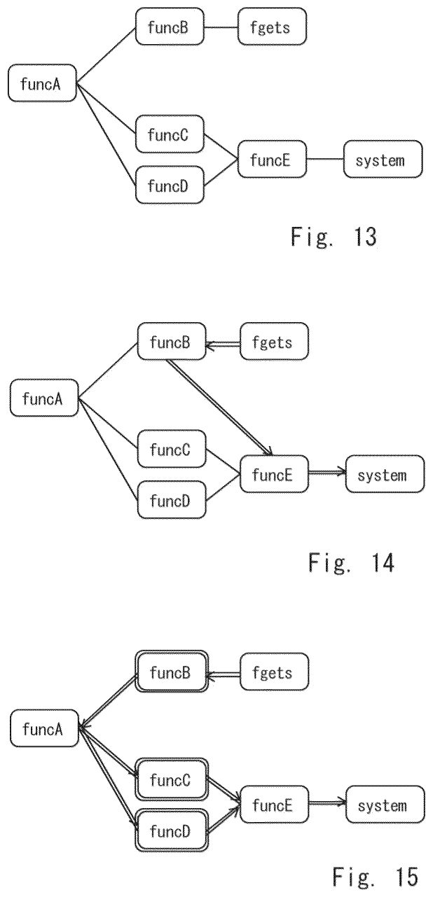

FIG. 15 shows another example of the directed graph generated by the graph integration unit 107. The graph integration unit 107 may display arrows indicating the control dependency relationship in accordance with a call relationship of functions. For example, as shown in FIG. 13, funcB is a function called from funcA. Further, funcE is a function called from funcC or funcD called from funcA. In this case, as shown in FIG. 15, the graph integration unit 107 may generate a directed graph having an arrow extended from funcB to funcA, arrows extended from funcA to funcC and funcD, and arrows extended from funcC and funcD to funcE. In this case, the graph integration unit 107 may highlight nodes indicating functions that generate a control dependency relationship with, for example, double lines or the like.

FIG. 16 shows yet another example of the directed graph generated by the graph integration unit 107. The function call relationship extraction unit 106 may expand nodes indicating functions called from a plurality of functions in a tree form in a graph indicating a call relationship of functions, like in the example of the directed graph shown in FIG. 8. The graph integration unit 107 may generate the directed graph shown in FIG. 16 by integrating the graph indicating a call relationship of functions expanded into a tree form with a directed graph indicating the control dependency relationship. Alternatively, the graph integration unit 107 may display arrows indicating the control dependency relationship in accordance with the call relationship of the functions in the graph indicating a call relationship of functions expanded into a tree form, like in the example of the directed graph shown in FIG. 15.

According to this example embodiment, the call relationship of functions, functions related to the control dependency, and the relationships therebetween may be displayed in the directed graph. In this case, the user is able to check not only the functions related to the control dependency but also the call relationship of the functions in the directed graph. The other effects are similar to those described in the first example embodiment.

In the above example embodiments, the example in which the input unit 101 acquires a source code of an inspection target program has been described. However, the present disclosure is not limited thereto. The input unit 101 may acquire an execution binary or an intermediate code of the inspection target program, instead of acquiring the source code. Further, in the aforementioned example embodiments, the example in which the dependency analysis unit 102 extracts lines on the source code that generate dependency relationships between variables has been described. However, the present disclosure is not limited thereto. The dependency analysis unit 102 may extract, for example, a code block, a statement, an intermediate code, or an assembly instruction of parts that generate dependency relationships. In this case, a code block, a statement, an intermediate code, or an assembly instruction of parts that generate a control dependency relationship may be displayed in the directed graph. Alternatively, parts that generate a control dependency relationship may be disassembled or decompiled, and the results of disassembling or decompiling may be displayed in the directed graph.

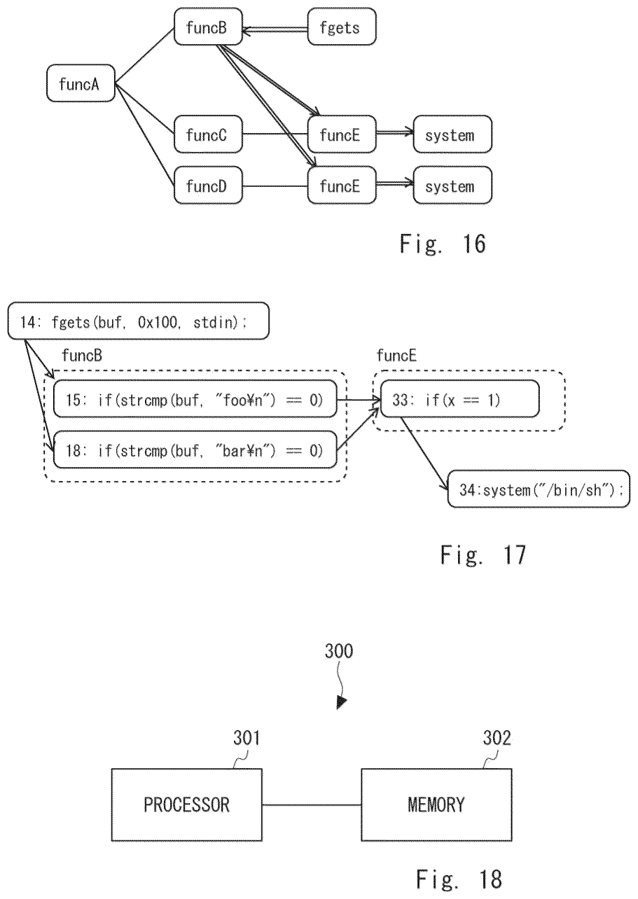

Each of the example embodiments stated above may be combined with another example embodiment as appropriate. For example, in the first example embodiment, the dependency analysis unit 102 may extract functions which codes for generating a control dependency relationship belong to according to an operation similar to that in the dependency analysis unit 102 in the second example embodiment. In this case, the directed graph generation unit 103 may display which function each node belongs to in the directed graph shown in FIG. 7. FIG. 17 shows an example of the directed graph in this case. In FIG. 17, nodes that correspond to the codes on the lines 15 and 18 of the source code are surrounded by predetermined frames such as dotted lines, and a label of funcB is added to the predetermined frames. Further, the node that corresponds to the code on the line 33 of the source code is surrounded by a predetermined frame such as a dotted line and a label of funcE is added to the predetermined frame. In this case, the user can easily know the codes that generate a control dependency relationship and functions to which these codes belong. Besides the function name, the namespace or the class name information on each function, and the source file name in which this function is implemented may be displayed.

Next, a hardware configuration of the information processing apparatus 100 will be described. FIG. 18 shows one example of a hardware configuration of a computer apparatus that may be used as the information processing apparatus 100. The computer apparatus 300 includes one or more processors 301 and one or more memories 302. The processor 301 may be, for example, a microprocessor, a Micro Processing Unit (MPU), or a Central Processing Unit (CPU).

The memory 302 stores a program executed by the processor 301. The memory 302 is composed of a combination of a volatile memory and a non-volatile memory. The memory 302 may include a storage located apart from the processor 301. In this case, the processor 301 may access the memory 302 via an Input/Output (I/O) interface or a network that is not shown.

The aforementioned program includes instructions or software codes that, when loaded into a computer, cause the computer to perform one or more of the functions described in the example embodiments. The program may be stored in a non-transitory computer readable medium or a tangible storage medium and may be supplied to the computer apparatus 300. By way of example, and not a limitation, computer readable media or tangible storage media can include a random-access memory (RAM), a read-only memory (ROM), a flash memory, a solid-state drive (SSD) or other types of memory technologies, a Compact Disc (CD), a digital versatile disc (DVD), a Blu-ray (registered trademark) disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

In the present disclosure, the information processing apparatus 100 may not necessarily be a single apparatus. The information processing apparatus 100 may be formed using a plurality of apparatuses physically separated from each other. For example, the information processing apparatus 100 may be formed using a server that provides the function of the dependency analysis unit 102 and a server that provides the function of the directed graph generation unit 103. At least some of the functions of each part of the information processing apparatus 100 may be provided by one or more cloud servers each performing predetermined processing.

Although the present disclosure has been described above with reference to the above example embodiments, the present disclosure is not limited to the above-described example embodiments. Various changes that may be understood by a person skilled in the art can be made to the configurations and the details of the present disclosure within the scope of the present disclosure.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an illustrative example embodiment are necessarily essential, and some features or steps may be omitted. The order of the steps described in any of the figures may be changed as appropriate.

An information processing apparatus, an information processing method, and a program according to the present disclosure enable a user to easily inspect the presence or the absence of a function executed when specific conditions are met.

The whole or part of the example embodiments disclosed above can be described as, but not limited to, the following supplementary notes.

### Supplementary Note 1

An information processing apparatus including:
a dependency analysis unit configured to execute a flow analysis on an inspection target program and analyze dependency relationships between variables in a process flow included in the inspection target program, the dependency relationships including a data dependency relationship and a control dependency relationship; and
a directed graph generation unit configured to generate, based on results of analyzing the dependency relationships, a directed graph having a part of the inspection target program that generates the control dependency relationship as a node regarding the process flow.

### Supplementary Note 2

The information processing apparatus according to Supplementary Note 1, wherein the directed graph generation unit generates a directed graph including, besides the node indicating the part that generates the control dependency relationship, a node indicating a starting point of the process flow and a node indicating an end point of the process flow.

### Supplementary Note 3

The information processing apparatus according to Supplementary Note 1 or 2, wherein the directed graph generation unit generates a directed graph having a code of a part of the inspection target program that generates the control dependency relationship as a node.

### Supplementary Note 4

The information processing apparatus according to Supplementary Note 3, wherein the directed graph generation unit generates a directed graph having a code of a part that generates the dependency relationships described in a source code of the inspection target program as a node.

### Supplementary Note 5

The information processing apparatus according to Supplementary Note 1 or 2, wherein the directed graph generation unit generates a directed graph having a function which the part of the inspection target program that generates the control dependency relationship belongs to as a node.

### Supplementary Note 6

The information processing apparatus according to Supplementary Note 5, further including a function integration processing unit configured to integrate, when parts that generate two or more control dependency relationships belong to one function, parts that generate the two or more control dependency relationships belonging to one function into one node.

### Supplementary Note 7

The information processing apparatus according to Supplementary Note 5 or 6, further including:
a function call relationship extraction unit configured to extract a call relationship of a plurality of functions included in the inspection target program; and
a graph integration unit configured to integrate the directed graph with a graph indicating the call relationship of the functions.

### Supplementary Note 8

The information processing apparatus according to Supplementary Note 7, wherein the graph integration unit highlights, in the graph in which the directed graph is integrated with the graph indicating the call relationship of the functions, a node indicating a function to which a part that generates the control dependency relationship belongs.

### Supplementary Note 9

The information processing apparatus according to Supplementary Note 7 or 8, wherein the graph integration unit omits a node of a function that is not related to either the data dependency relationship or the control dependency relationship, of the functions included in the inspection target program, in the integrated graph.

### Supplementary Note 10

The information processing apparatus according to any one of Supplementary Notes 1 to 9, wherein the dependency analysis unit analyzes a process flow having a first function for externally receiving data as a starting point and a second function in which predetermined processing is executed as an end point.

### Supplementary Note 11

The information processing apparatus according to Supplementary Note 10, wherein the dependency analysis unit analyzes variables which have a data dependency relationship or a control dependency relationship with data input in the first function.

### Supplementary Note 12

The information processing apparatus according to any one of Supplementary Notes 1 to 11, wherein the data dependency relationship indicates a relationship in which a value of a variable of a dependency destination is derived from a variable of a dependency source and the control dependency relationship indicates a relationship in which the value of the variable of the dependency destination is changed or generated as a result of the branch of processing depending on the variable of the dependency source.

### Supplementary Note 13

An information processing method including:
executing a flow analysis on an inspection target program and analyzing dependency relationships between variables in a process flow included in the inspection target program, the dependency relationships including a data dependency relationship and a control dependency relationship; and
generating, based on results of analyzing the dependency relationships, a directed graph having a part of the inspection target program that generates the control dependency relationship as a node regarding the process flow.

### Supplementary Note 14

A program for causing a computer to execute processing including:
executing a flow analysis on an inspection target program and analyzing dependency relationships between variables in a process flow included in the inspection target program, the dependency relationships including a data dependency relationship and a control dependency relationship; and
generating, based on results of analyzing the dependency relationships, a directed graph having a part of the inspection target program that generates the control dependency relationship as a node regarding the process flow.

Note that some or all of the elements, such as the configurations and the functions, according to Supplementary Notes 2 to 12 that depend from Supplementary Note 1 may depend from Supplementary Notes 13 and 14 as well according to a dependency relationship similar to that in Supplementary Notes 2 to 12. Some or all of the elements according to any Supplementary Note may be applied to various kinds of hardware, software, recording means for recording software, system, and method.

What is claimed is:

1. An information processing apparatus comprising:
at least one memory storing instructions, and
at least one processor configured to execute the instructions to:
execute a flow analysis on an inspection target program and analyze dependency relationships between variables in a process flow included in the inspection target program, the dependency relationships including a data dependency relationship and a control dependency relationship; and
generate, based on results of analyzing the dependency relationships, a directed graph having a part of the inspection target program that generates the control dependency relationship as a node regarding the process flow.

2. The information processing apparatus according to claim 1, wherein the at least one processor is configured to execute the instructions to generate a directed graph including, besides the node indicating the part that generates the control dependency relationship, a node indicating a starting point of the process flow and a node indicating an end point of the process flow.

3. The information processing apparatus according to claim 1, wherein the at least one processor is configured to execute the instructions to generate a directed graph having a code of a part of the inspection target program that generates the control dependency relationship as a node.

4. The information processing apparatus according to claim 3, wherein the at least one processor is configured to execute the instructions to generate a directed graph having a code of a part that generates the dependency relationships described in a source code of the inspection target program as a node.

5. The information processing apparatus according to claim 1, wherein the at least one processor is configured to execute the instructions to generate a directed graph having a function which the part of the inspection target program that generates the control dependency relationship belongs to as a node.

6. The information processing apparatus according to claim 5, wherein the at least one processor is configured to execute the instructions to integrate, when parts that generate two or more control dependency relationships belong to one function, parts that generate the two or more control dependency relationships belonging to one function into one node.

7. The information processing apparatus according to claim 5, wherein
the at least one processor is configured to execute the instructions to:
extract a call relationship of a plurality of functions included in the inspection target program; and
integrate the directed graph with a graph indicating the call relationship of the functions.

8. The information processing apparatus according to claim 7, wherein the at least one processor is configured to execute the instructions to highlight, in the graph in which the directed graph is integrated with the graph indicating the call relationship of the functions, a node indicating a function to which a part that generates the control dependency relationship belongs.

9. The information processing apparatus according to claim 7, wherein the at least one processor is configured to execute the instructions to omit a node of a function that is not related to either the data dependency relationship or the control dependency relationship, of the functions included in the inspection target program, in the integrated graph.

10. The information processing apparatus according to claim 1, wherein the at least one processor is configured to execute the instructions to analyze a process flow having a first function for externally receiving data as a starting point and a second function in which predetermined processing is executed as an end point.

11. The information processing apparatus according to claim 10, wherein the at least one processor is configured to execute the instructions to analyze variables which have a data dependency relationship or a control dependency relationship with data input in the first function.

12. The information processing apparatus according to claim 1, wherein the data dependency relationship indicates a relationship in which a value of a variable of a dependency destination is derived from a variable of a dependency source and the control dependency relationship indicates a relationship in which the value of the variable of the dependency destination is changed or generated as a result of the branch of processing depending on the variable of the dependency source.

13. An information processing method comprising:
executing a flow analysis on an inspection target program and analyzing dependency relationships between variables in a process flow included in the inspection target program, the dependency relationships including a data dependency relationship and a control dependency relationship; and
generating, based on results of analyzing the dependency relationships, a directed graph having a part of the inspection target program that generates the control dependency relationship as a node regarding the process flow.

14. A non-transitory computer readable medium storing a program for causing a computer to execute processing including:
executing a flow analysis on an inspection target program and analyzing dependency relationships between variables in a process flow included in the inspection target program, the dependency relationships including a data dependency relationship and a control dependency relationship; and
generating, based on results of analyzing the dependency relationships, a directed graph having a part of the inspection target program that generates the control dependency relationship as a node regarding the process flow.
